(19) United States
(12) Patent Application Publication
(10) Pub. No.: US 2003/0028870 A1
(43) Pub. Date: Feb. 6, 2003

(54) Distribution of downloadable software over a network

(76) Inventors: Mitchell T. Weisman, San Carlos, CA (US); Anthony G. Martin, Los Altos, CA (US); David L. Chambers, Elkins, NH (US)

Correspondence Address: SQUIRE, SANDERS & DEMPSEY L.L.P, 600 HANSEN WAY, PALO ALTO, CA, 94304-1043, US

(21) Appl. No.: 10/056,955

(22) Filed: Jan. 25, 2002

Related U.S. Application Data
(60) Provisional application No. 60/309,634, filed on Aug. 1, 2001.

(51) Int. Cl. G06F 9/445

(52) U.S. Cl. 717/178; 717/173

(57) ABSTRACT

In one embodiment, a first stage software is bundled together with a first downloadable software available from a first server computer. The first stage software includes computer instructions for downloading a second downloadable software available from a second server computer. When an end-user wishes to download the first downloadable software, the second downloadable software is also offered to the end-user. Accepting the offer results in the first stage software downloading the second downloadable software onto the end-user's client computer. In one embodiment, the second downloadable software is downloaded in chunks.

### CROSS-REFERENCE TO RELATED APPLICATIONS

This application claims the benefit of U.S. Provisional Application No. 60/309,634, entitled “DISTRIBUTION OF DOWNLOADABLE SOFTWARE OVER A NETWORK,” filed on Aug. 1, 2001 and which is incorporated by reference herein. This application also claims benefit of U.S. Provisional Application No. 60/______ , filed Oct. 18, 2001 by United States Postal Service Express Mail Serial No. EL701362699US, entitled, “SYSTEM METHOD AND COMPUTER PROGRAM PRODUCT FOR COLLECTING INFORMATION ABOUT A NETWORK USER” (Attorney Reference No. 50642.00028) and which is incorporated by reference herein.

### BACKGROUND OF THE INVENTION

1. Field of the Invention

This invention relates generally to computer software, and more particularly to distribution of computer software over a network.

2. Description of the Background Art

As is well known, computers perform specific tasks by following a set of instructions commonly known as “software”. A piece of software can be distributed to end-users by storing the software on removable storage media such as floppy diskettes or compact disks, and making the storage media available to the users. Typically, the storage medium includes the software to be installed and an installer. The installer is a specialized piece of software designed to assist users in the installation process. A user starts the installation process by inserting the storage medium in a storage medium reader (e.g., floppy drive, CD-ROM drive, etc.) of a computer, and then invoking the installer. In some operating systems, the installer is automatically invoked as soon as the storage medium is inserted in the reader. The installer asks the user a series of questions regarding her preferences as to file storage locations, the amount of files to install, default settings, etc. Thereafter, the installer proceeds to copy the software from the storage medium to the computer's mass storage device (e.g., hard disk drive), and performs any necessary configuration changes in accordance with the user's preferences.

Software can also be distributed by making the software available for download over a network. In that case, the software is stored on a server coupled to the network. A user who wishes to obtain the software couples her computer onto the network, and downloads the software from the server to her computer. The convenience of being able to obtain software at any time and the widespread availability of public networks such as the Internet contribute to the popularity of downloadable software.

Downloading software over a network is not without its share of problems. On the Internet, for example, a software vendor has to somehow alert potential users that a particular piece of software is available for download. Considering the cost of advertising and the number of competing software available on the Internet, an effective technique for informing potential users of the existence of the downloadable software, and convincing them to download the software, is highly desirable.

The amount of time required to download software over a network affects the chances of having an error-free download and the users allowing the download to complete. If the download process takes a long time, such as when the software is large or the network connection is slow, there is a tendency for users to cancel the download prior to completion. Worse, transmission errors may occur in the middle of the download. Thus, a technique for increasing the likelihood of having a complete and successful download is also highly desirable.

### SUMMARY

The present invention relates to an improved technique for downloading and distributing downloadable software over a network. The invention may be used in a wide variety of applications including in the distribution of software over the Internet.

In one embodiment, a first stage software is bundled together with a first downloadable software available from a first server computer. The first stage software includes computer instructions for downloading a second downloadable software available from a second server computer. When an end-user wishes to download the first downloadable software, the second downloadable software is also offered to the end-user. Accepting the offer results in the first stage software downloading the second downloadable software onto the end-user's client computer.

In one embodiment, the first stage software is a relatively small executable file, making the first stage software more appealing to partners who would otherwise be reluctant to bundle their software with somebody else's.

In one embodiment, the second software is divided into several chunks that can be individually downloaded to the client computer. This decreases the chance of the end-user prematurely canceling the download or encountering transmission errors in the middle of the download.

These and other features and advantages of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic diagram of a computer network in accordance with an embodiment of the present invention.

FIGS. 2A-2J are example screen shots, as seen by an end-user on a client computer, illustrating a download process in accordance with an embodiment of the present invention.

FIG. 3A schematically illustrates a first stage software in accordance with an embodiment of the present invention.

FIG. 3B schematically illustrates a downloadable software that is divided into a series of portions in accordance with an embodiment of the present invention.

FIG. 4 shows a method for distributing a downloadable software in accordance with an embodiment of the present invention.

FIG. 5 shows a method for downloading a downloadable software in accordance with an embodiment of the present invention.

FIG. 6 schematically illustrates a first stage software in accordance with another embodiment of the present invention.

FIG. 7A schematically illustrates the division of a file in chunks in accordance with an embodiment of the present invention.

FIG. 7B schematically illustrates a time domain multiplexing for downloading a file in accordance with an embodiment of the present invention.

FIG. 8 schematically illustrates exemplary files downloaded from a server computer in accordance with an embodiment of the present invention.

FIG. 9 shows a method for downloading files in accordance with an embodiment of the present invention.

FIG. 10 shows a method for downloading a file in chunks in accordance with an embodiment of the present invention.

The use of the same reference label in different drawings indicates the same or like components.

### DETAILED DESCRIPTION

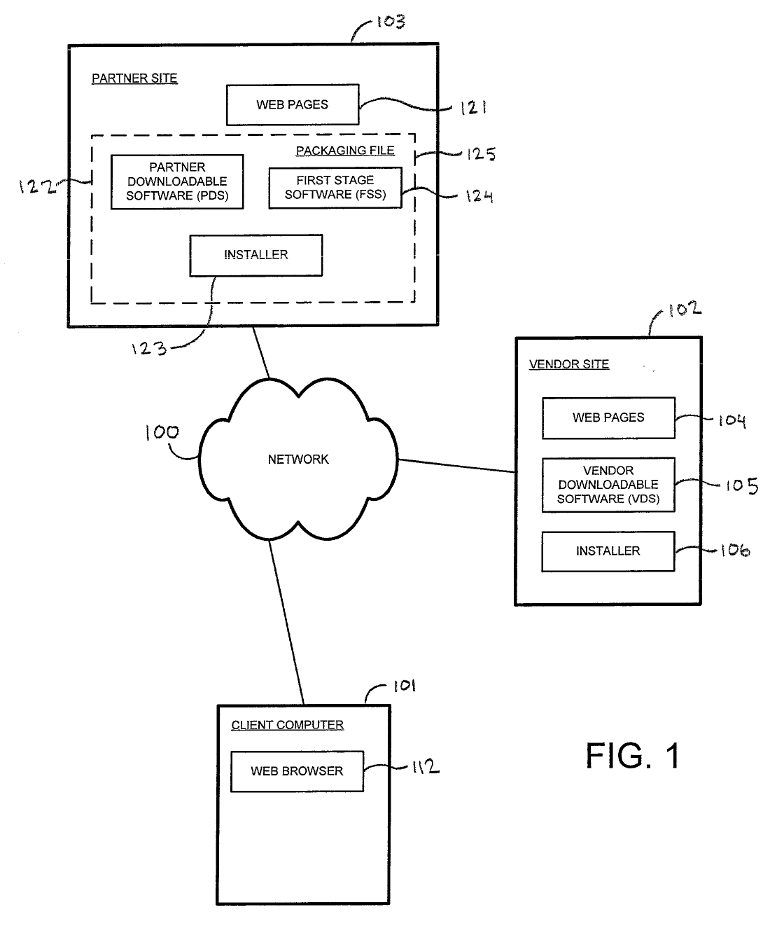

Referring to FIG. 1, there is shown a schematic diagram of a computer network in accordance with an embodiment of the present invention. A computer network 100 couples together a client computer 101, a vendor site 102, a partner site 103, and other computers not specifically shown. Network 100 may be any type of computer network; in this embodiment, network 100 is a public network such as the Internet.

Client computer 101 may be any type of computer that provides an end-user access to a network. In this embodiment, client computer 101 is a personal computer running either the Microsoft Windows™, Apple Macintosh™, Linux, or UNIX operating system. Client computer 101 includes a web browser 112 such as the Microsoft Internet Explorer™ or Netscape Navigator™. An end-user on client computer 101 employs web browser 112 to view web pages stored on various sites on network 100.

Vendor site 102 is a web site that includes web pages 104, one or more vendor downloadable software 105, and an installer 106. As can be appreciated, vendor site 102, and other sites in the present disclosure, may be implemented using a server computer such as those available from Sun Microsystems™, the Hewlett-Packard Company™, or International Business Machines™. Web pages 104 contain information that can be viewed over network 100 using a web browser. For example, web pages 104 may contain news, maps, coupons, free services, directories, and other types of information that will attract end-users to vendor site 102. As shown in FIG. 1, a vendor downloadable software (VDS) 105 is available for download from vendor site 102. VDS 105 may be any type of software including application software. For example, VDS 105 may be a screen saver, a video game, a device driver, music, wallpaper, electronic book, or software for filling out electronic forms and login screens on the Internet. VDS 105, and other downloadable software in the present disclosure, may be stored on vendor site 102 or on another site linked thereto. VDS 105, and other downloadable software in the present disclosure, may consist of a single file or a group of files.

For various reasons, it is desirable to have end-users download VDS 105. One reason may be that end-users employing VDS 105 will have to pay licensing fees. Another reason may be that the use of VDS 105 in an end-user's computer allows for some form of advertising. Another reason may be that the vendor operating vendor site 102 charges another vendor, who happens to own VDS 105, a fee whenever an end-user downloads VDS 105. Whatever the reason, it is desirable to distribute VDS 105 to as many end-users as possible.

Installer 106 is also available for download from vendor site 102. Installer 106 assists the end-user in installing and configuring the various VDS 105 available from vendor site 102. Installer 106 may be downloaded separately as depicted in FIG. 1, or as part of a VDS 105. That is, installer 106, and other installers in the present disclosure, may also be incorporated in a corresponding VDS 105.

Partner site 103 is a web site that includes its own set of web pages (web pages 121), downloadable software (partner downloadable software 122), and installers (installer 123). To increase the exposure of VDS 105 to potential end-users, the vendor operating vendor site 102 (hereinafter referred to as “vendor”) contracts with the vendor operating partner site 103 (hereinafter referred to as “partner”) to make a first stage software (FSS) 124 available for download from partner site 103. As will be discussed below, FSS 124 facilitates the downloading of VDS 105 to any computer on network 100. Essentially, the partner agrees to offer VDS 105 to end-users viewing web pages 121 or to those who want to download a partner downloadable software (PDS) 122 from partner site 103.

PDS 122, FSS 124, and installer 123 may be contained in a packaging file 125. In this embodiment, packaging file 125 is a compressed, executable file that simplifies the download process by including all files necessary to install and run PDS 122 on a client computer. Of course, PDS 122, FSS 124, and installer 123 may also be separately stored and individually downloaded.

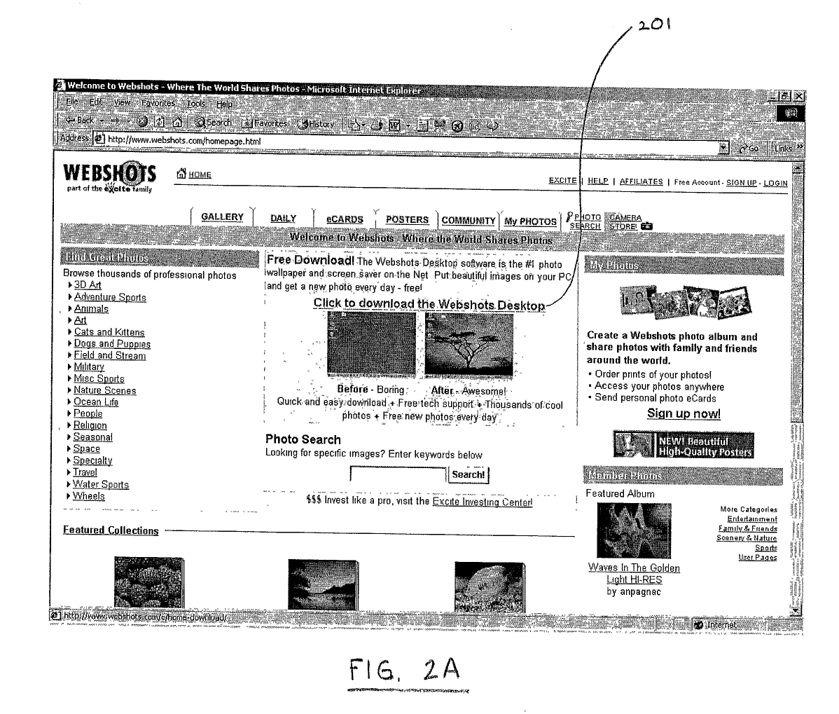

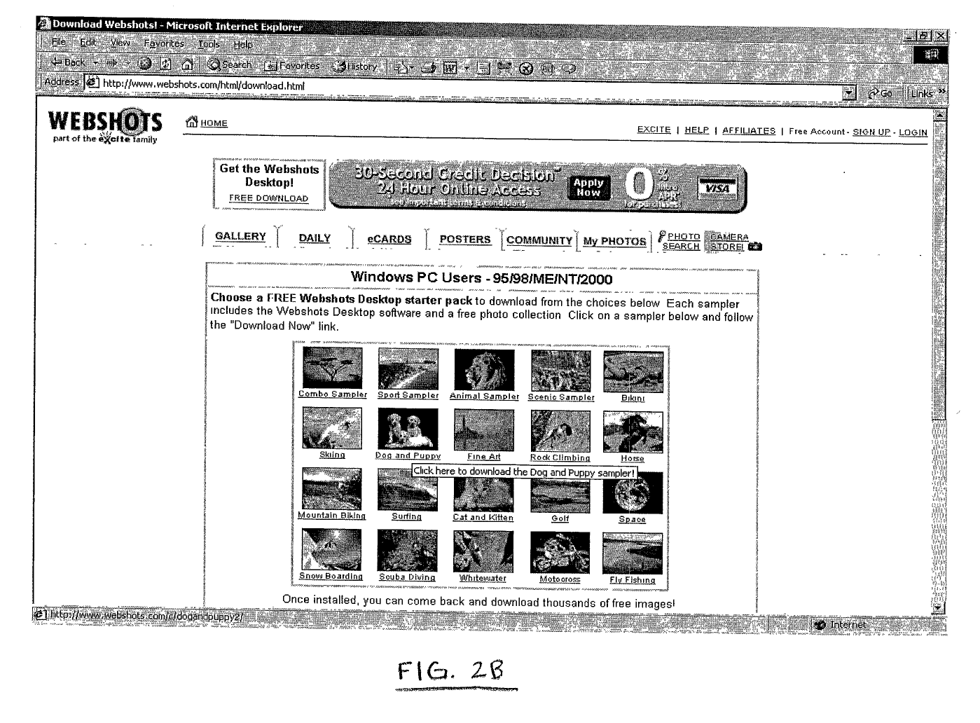

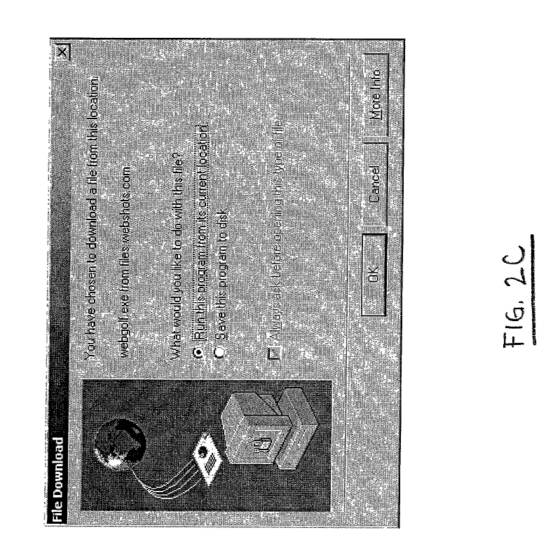

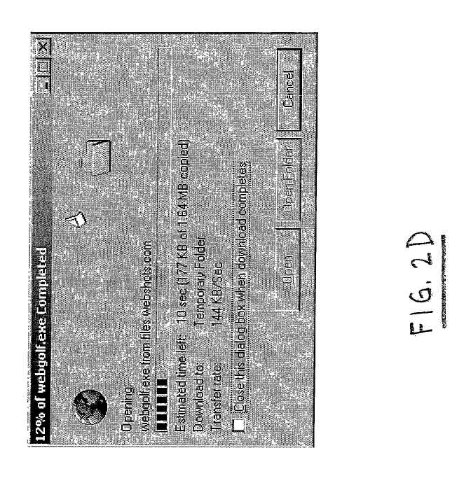

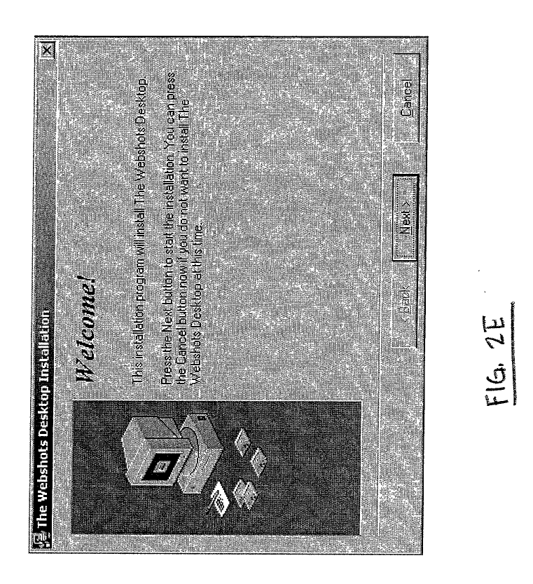

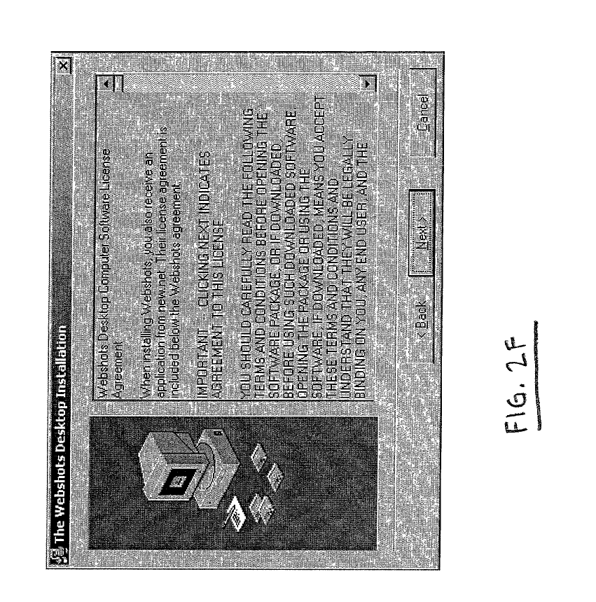

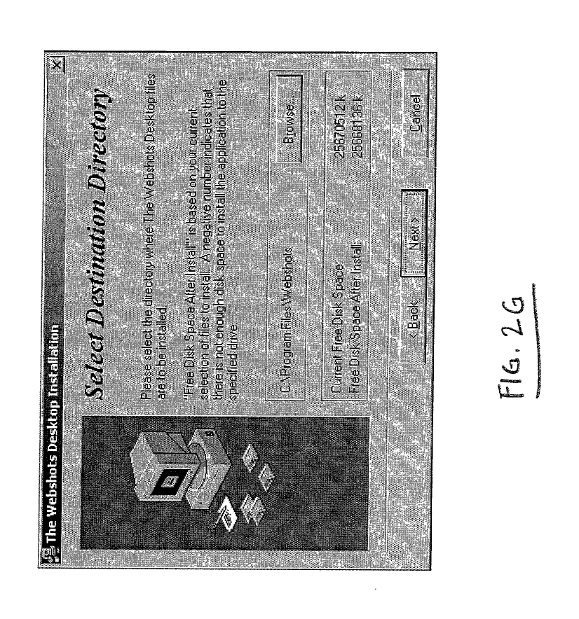

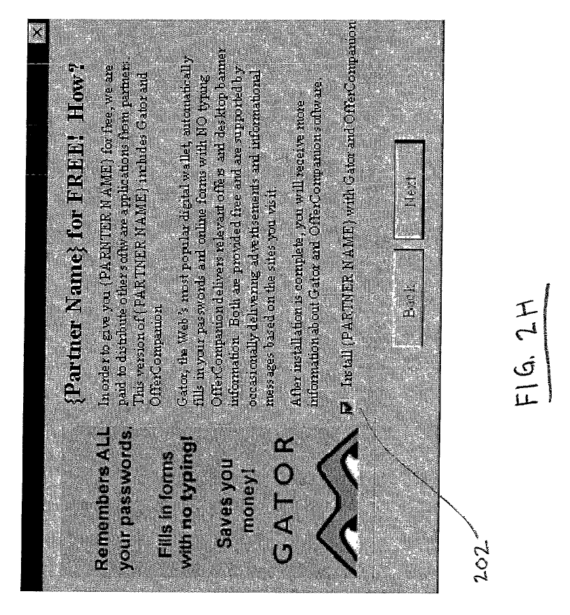

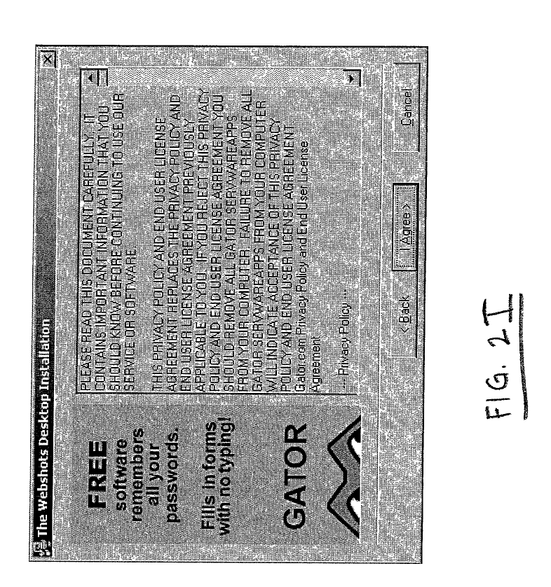

FIGS. 2A-2J are example screen shots, as seen by an end-user on client computer 101, illustrating a download process in accordance with an embodiment of the present invention. Note that the screen shots of FIGS. 2A-2J are provided for illustration purposes only, and do not imply that a business relationship exists between Gator.com™, the assignee of the present disclosure, and the copyright owner of the screen shots. Furthermore, intermediate screen shots that are not necessary to the understanding of the present invention are not shown for the sake of clarity. FIG. 2A shows an example web page from a partner site 103 offering several PDS 122, which in this example are wallpapers and screen savers. Clicking on hyperlink message 201 brings up the web page shown in FIG. 2B. As shown in FIG. 2B, the end-user is provided several PDS 122 to choose from. Clicking on any selection initiates the download of a packaging file 125 containing the selected PDS 122 onto client computer 101. The packaging file 125 may be downloaded directly from partner site 103, or from another site linked to partner site 103. In FIG. 2C, the end-user is given the option to either run the packaging file 125 from partner site 103 or save the packaging file 125 on client computer 101. Choosing the save option results in the downloading of the packaging file 125 onto client computer 101, and allows the end-user to run the packaging file 125 at a later time. Choosing the run from partner site 103 option results in the downloading of packaging file 125 onto client computer 101, and running of the packaging file 125 immediately after the download has completed. FIG. 2D is an example screen shot showing the downloading of the packaging file 125.

In FIG. 2E, the end-user is given the option to cancel out of the installation process. If the end-user proceeds with the installation, she is presented with a license agreement covering the use and ownership of the selected PDS 122 as shown in FIG. 2F. Otherwise, the installation process is halted. In FIG. 2G, the end-user specifies a location in client computer 101 where the selected PDS 122 is to be installed.

In accordance with the agreement between the vendor and the partner, VDS 105 is offered to the end-user as shown in FIG. 2H. The end-user agrees to get VDS 105 by placing a check mark on checkbox 202. If the end-user agrees to have VDS 105, she is presented with a license agreement covering the use and ownership of VDS 105 as shown in FIG. 21. Agreeing to the license agreement starts the installation of the selected PDS 122 and VDS 105 on client computer 101. In FIG. 2J, the end-user is notified after the completion of the installation process.

Referring again to FIG. 1, FSS 124, and not VDS 105, is bundled with PDS 122 in a packaging file 125. In this embodiment, FSS 124 is a relatively small (e.g., file size less than about 100 Kbytes when compressed) executable file that downloads VDS 105 onto any computer coupled to network 100. The relatively small size of FSS 124 makes it ideal for bundling with downloadable software on partner sites. That is, a partner is more likely to agree to bundle FSS 124 with his software than VDS 105. This is because the relatively large size of VDS 105 will slow down the downloading of the partner's PDS 122, thereby increasing the likelihood of end-users prematurely canceling the download process or encountering a transmission error in midstream. The more partners agree to bundle FSS 124 with their downloadable software, the more VDS 105 will get distributed to end-users.

Bundling FSS 124 with PDS 122 also simplifies the distribution process. Because FSS 124 is not an inherent part of VDS 105, and merely downloads a specific file (or files) from vendor site 102, VDS 105 can be updated without having to update FSS 124. Additionally, the size of FSS 124 can be kept relatively small regardless of the size or number of VDS 105 to download.

In another embodiment, the partner's software is distributed on removable storage medium such as a CD-ROM, for example. In that case, VDS 105 is offered to the end-user during the installation of the partner's software. If the end-user accepts, FSS 124 is copied from the CD-ROM to the end-user's computer, and then run to download VDS 105 off vendor site 102.

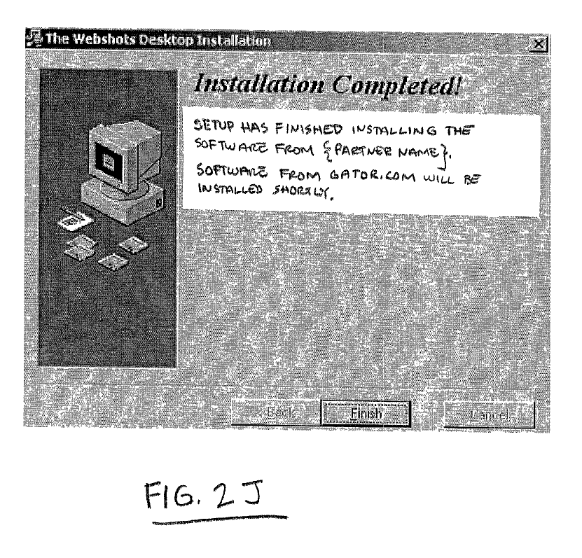

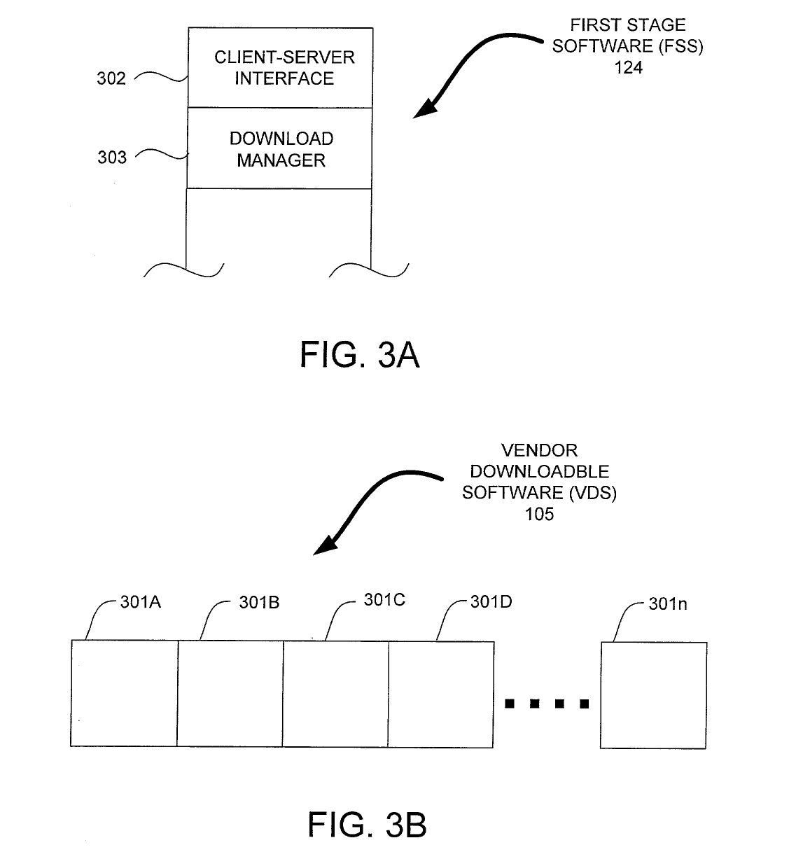

FIG. 3A schematically illustrates an FSS 124 in accordance with an embodiment of the present invention. As shown in FIG. 3A, an FSS 124 includes a client-server interface 302 and a download manager 303. Client-server interface 302 allows an FSS 124 running on a client computer 101 to communicate with a vendor site 102, which is a server computer in this embodiment. Client-server interface 302 includes computer instructions for client-server communication, checking-in with vendor site 102, and authentication. The information passed-on by FSS 124 to vendor site 102 upon checking-in includes the identity of the partner site it came from (e.g., for billing purposes) and its version number.

As shown in FIG. 3A, an FSS 124 also includes a download manager 303 for downloading one or more VDS 105 from vendor site 102 or from another site linked to vendor site 102. Download manager 303 obtains the names of VDS 105 to download and their respective locations. Download manager 303 includes computer instructions for copying a VDS 105 from its location in vendor site 102 (or another site linked thereto) onto a location in client computer 101. Download manager 303 may download a single file containing the entirety of a VDS 105, or a series of small portions each containing a portion of the VDS 105.

FIG. 3B schematically illustrates a VDS 105 that is divided into a series of small portions, each of which is referred to herein as a chunk 301 (i.e., 301A, 301B, . . . 301n), in accordance with an embodiment of the present invention. In that embodiment, download manager 303 downloads chunks 301 individually, one after another. That is, download manager 303 first downloads chunk 301A onto client computer 101, then chunk 301B, then chunk 301C, and so on. After all chunks 301 have been downloaded on client computer 101, download manager 303 then reassembles the chunks 301 into a VDS 105. Reassembly of the chunks 301 in client computer 101 may be performed several ways. For example, chunk 301A, the first chunk to be downloaded by download manager 303, could be designated as a control chunk and include information for assembling chunks 301 B, 301C, 301D . . . 301n together. Chunk 301A could also include a more sophisticated (and larger) set of computer instructions for downloading the rest of VDS 105. Another way is to include headers in each chunk 301, with each header having reassembly information such as the order number of the current chunk, and the respective order numbers of the preceding and following chunks. In that case, the headers are removed by download manager 303 as the chunks are reassembled in client computer 101. As can be appreciated, other ways of downloading a piece of software in chunks can also be used without detracting from the merits of the present invention. It is to be noted that techniques for dividing a piece of software into a series of small portions, individually downloading each portion onto a computer, and reassembling the piece of software in the computer (also known as “trickling”), in general, are known in the art.

Download manager 303 can be configured to download each chunk 301 depending, for example, on the amount of available bandwidth in the network connection of client computer 101, the time of day, or the need of the end-user. For example, download manager 303 can be configured to download one chunk 301 at a time if the network connection is a 28 KBPS dial-up connection, or three chunks 301 at a time if the network connection is a T1 line. As another example, download manager 303 can be configured to download the chunks 301 over a span of one week or the next two hours. As a further example, download manager can be configured to schedule the download at the most opportune time (e.g., midnight).

As can be appreciated, the flexibility of downloading VDS 105 in chunks makes the downloading process more reliable. Furthermore, downloading in chunks does not tie-up the client computer 101, and can be spread out in time such that the end-user barely notices that a download is in progress.

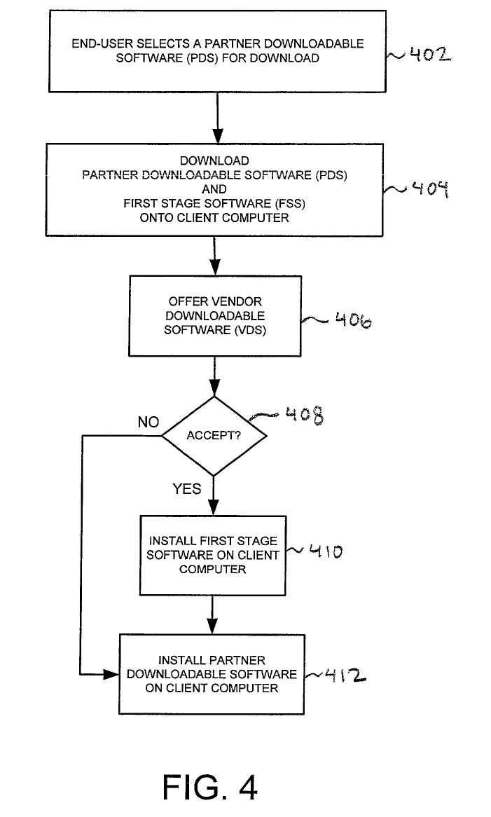

FIG. 4 shows a method for distributing a VDS 105 in accordance with an embodiment of the present invention. In action 402, an end-user selects a PDS 122 for download from a partner site 103. In action 404, the selected PDS 122 is downloaded from partner site 103 to the end-user's client computer 101. As part of the partner's bundling agreement with the vendor, an FSS 124 is also downloaded from partner site 103 to client computer 101 (see action 404). In action 406, the vendor's VDS 105 is offered to the end-user. If the end-user agrees to have the VDS 105, FSS 124 is installed on client computer 101, as noted in action 410. As part of its installation process, FSS 124 is decompressed (if compressed) and then automatically invoked to download the VDS 105 either as a single file or in chunks depending on implementation. In action 412, the selected PDS 122 is installed on client computer 101. Optionally, FSS 124 is deleted off client computer 101 if the end-user declines to have the VDS 105; in any event, FSS 124 is too small to have an impact on the storage capacity of client computer 101.

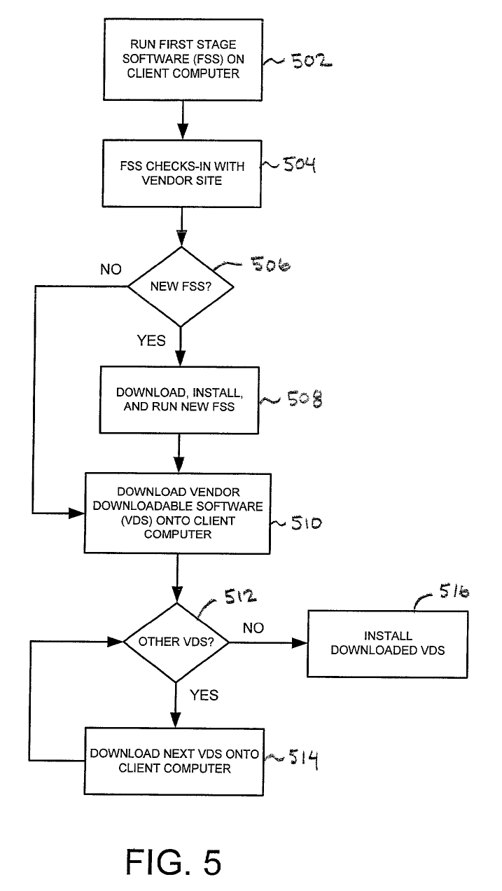

FIG. 5 shows a method for downloading a VDS 105 in accordance with an embodiment of the present invention. In action 502, a previously installed FSS 124 is run on client computer 101. In action 504, FSS 124 checks-in with vendor site 102. During the check-in process, FSS 124 is authenticated as a client authorized to download data (including files) from vendor site 102. In action 506, FSS 124 determines if a newer version of FSS 124 is available. If so, the new FSS 124 is downloaded on client computer 101 and run instead of the old FSS 124, as noted in action 508.

In action 510, FSS 124 downloads the VDS 105 onto client computer 101. The VDS 105 is either downloaded as a single file or in chunks depending on implementation. Additionally, other software for supporting VDS 105 (e.g., an installer if one is not included in VDS 105) are also downloaded at this time. In action 512, FSS 124 determines if there are other VDS 105 offered to and selected by the end-user. If so, FSS 124 proceeds to download each of them, as noted in action 514. In action 516, all downloaded VDSs 105 are installed on client computer 101.

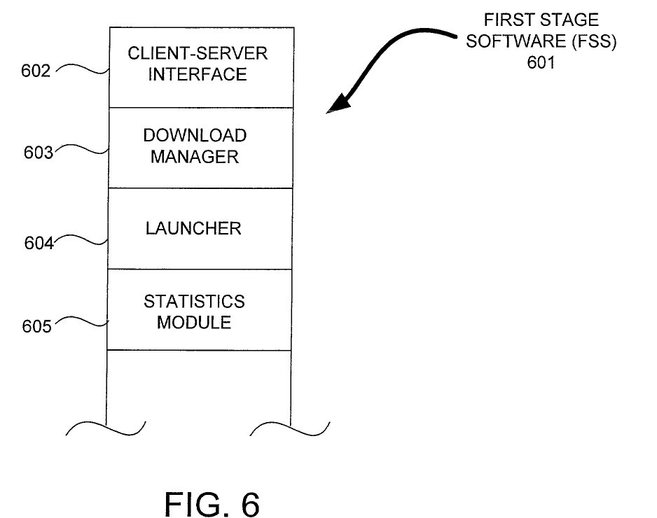

Referring now to FIG. 6, there is shown a schematic representation of a first stage software (FSS) 601, in accordance with another embodiment of the present invention. FSS 601 is a relatively small (e.g., 100 Kbytes when compressed) piece of software that facilitates the downloading of files to a client computer. FSS 601 runs in a client computer such as client computer 101. FSS 601 may be bundled with a partner software downloadable from a server computer or partner software distributed on removable storage media. It should be understood, however, that FSS 601 may be used in any application requiring downloading of files, and not necessarily limited to software bundling applications.

FSS 601 includes a client-server interface 602, a download manager 603, a launcher 604, and a statistics module 605. Client-server interface 602 includes computer instructions that allow FSS 601 to communicate with a server computer such as vendor site 102.

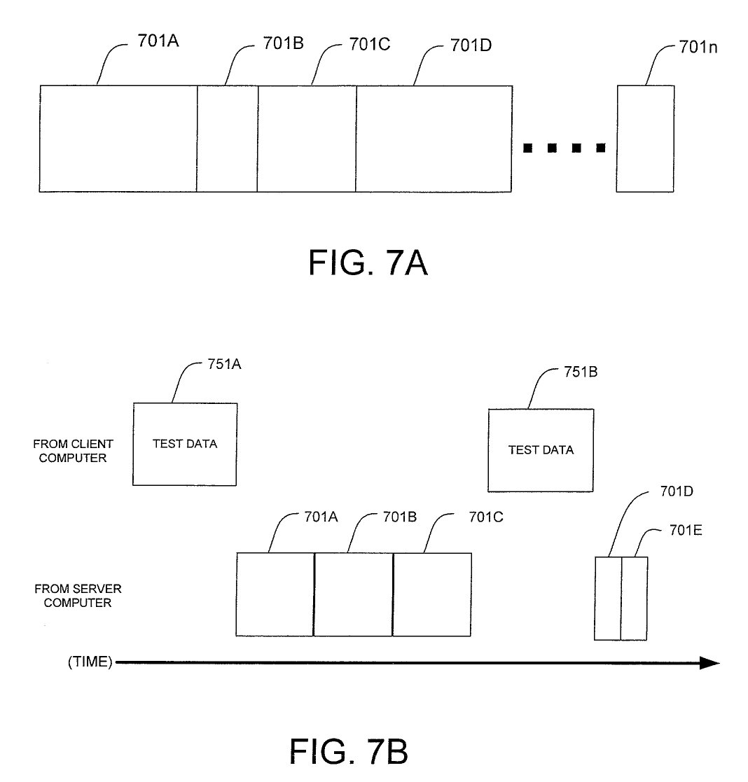

A download manager 603 includes computer instructions for downloading one or more files (e.g., VDS 105 and support software) from a server computer to a client computer running FSS 601. In this embodiment, download manager 603 downloads files using the Hypertext Transfer Protocol (HTTP). Download manager 603 may download a single file in its entirety, or download a single file in small portions. This aspect of the present invention is now described in connection with FIG. 7A.

In FIG. 7A, chunks 701A, 701B, 701 C, . . . 701n compose a single file. Using HTTP, download manager 603 asks the server computer to download specific portions of the single file. For example, download manager 603 may ask the server for bytes 1 to 500 of VDS 105 and designate that portion as chunk 701A, for bytes 501 to 532 of VDS 105 and designate that portion as chunk 701 B, for bytes 533 to 600 of VDS 105 and designate that portion as chunk 701 C, etc. The size of each chunk may be varied by varying the byte range. Thus, download manager 603 has the capability to download a single file in chunks. If there are several files to download, each file is downloaded in chunks until all the files are downloaded.

FIG. 7B schematically illustrates a time domain multiplexing technique employed by download manager 603 in accordance with an embodiment of the present invention. In this embodiment, the download manager 603 requests chunks (701A, 701B, 701C, . . . 701n) of the file that is being downloaded. Each chunk is downloaded at what the download manager 603 believes to be the connection's full transfer rate. The duration of the download of the chunk is measured. The duration of the download of the chunk 701A may be shown as T701A. Assuming that the bandwidth available for the download is 25% of the total bandwidth, this available percentage may be shown as pct. Once the 701A chunk is entirely received, DM603 will then sleep for a time equal to (T701A/pct)*(1-pct). For example, if T701A is 500 mS, meaning that it has taken 500 mS to download the first chunk of the file and the pct is 25%, meaning that the 25% of the total available bandwidth is going to be used for download of the chunk, once 701A is entirely received, the download manager 603 will then sleep for (T701A/pct)*(1-pct)=(500/0.25)*(1-0.25)=1500 mS. Therefore, downloading takes 25% of the time slice, or 500 mS, and sleeping takes the other 75%, or 1500 mS.

The actual download and sleep durations are The actual download and sleep durations are constantly changing based on each successive chunk's download duration, but download manager 603 is always consuming only 25% of the bandwidth on the average (100% of the bandwidth for 25% of the time, 0% of the bandwidth for 75% of the time). Should another application begin using bandwidth (e.g. internet telephony), T701x (the time for download manager to download any generic chunk of the file 701x) will grow from 500 ms to a much larger number and/or the chunk size will reduce, and the sleep time will change proportionally, but download manager 603 will still consume, on the average, about 25% of available bandwidth. When the other application ceases consuming bandwidth, the T701x download durations will shrink and the respective sleep durations will shrink accordingly. An analogy to the metering lights on freeway onramps may be used to clarify this embodiment. On these metering lights, the interval between green lights is inversely proportional to freeway congestion.

The download manager 603 determines the transmit time by measuring the time in milliseconds from http request to the response received. All network variables, such as DNS resolution, latency, server load, etc., are thus accounted for. One embodiment of the download manager 603 is capable of using any generic HTTP server. In this embodiment, the server need not monitor the time and durations of transfer as the download manager 603 handles this monitoring.

From the foregoing, the transmission of a test data 751 enables download manager 603 to determine the amount of bandwidth currently being consumed by the end-user. This allows download manager 603 to adjust the size of each chunk 701 and the amount of time to be used in downloading a series of chunks 701 such that the end-user barely notices that a download to her client computer is in-progress.

Referring to FIG. 7B, as an example of a transmit situation, on a cable modem that runs between 600 kbps and 1.2 Mbps download rate, downloading a 64 Kbyte chunk, with no other applications taking up bandwidth, takes between 500 and 1200 mS. Download manager 603 starts out with an 8 Kbyte chunk and increases the chunk size until it finds a reasonable rate. For example, chunk sizes on 56 k modem connections will be in the 8 to 16 Kbyte range; higher speed connections quickly ratchet up to 64 Kbytes per chunk that may be allowed by data manager 603.

Download manager 603 further includes computer instructions for keeping track of the chunks 701 already downloaded to the client computer. This allows download manager 603 to determine the last chunk 701 successfully downloaded, which is useful information in case of a download error (e.g., due to a connection failure). In that case, download manager 603 may be restarted to download the next chunk following the last successfully downloaded chunk 701, rather than having to begin the download process again from the very beginning.

Download manager 603 further includes computer instructions for reassembling all the downloaded chunks 701 in the client computer.

As can be appreciated, downloading a single file in chunks in accordance with this embodiment of the present invention increases the likelihood of successfully completing a download, minimizes the impact of the download process on the end-user, and allows for download using slow network connections.

Referring again to FIG. 6, FSS 601 further includes a launcher 604 for running software downloaded by download manager 603. Statistics module 605 keeps track of statistical information relating to the use of FSS 601. This statistics module may reside in the client machine. Thus, statistics generated by the statistics module may periodically be transmitter via the network to the vendor server. In one embodiment, statistics module 605 includes computer instructions for keeping track of the number of times a specific piece of software has been downloaded from the server, the number of successful and unsuccessful downloads, error codes relating to unsuccessful downloads, the identity of the partner who bundled FSS 601, etc. Such information allows the partner to be paid (or billed) for every successful download and enables software developers to optimize the download process, for example.

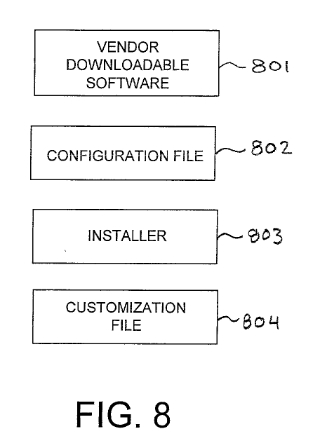

FIG. 8 schematically illustrates exemplary files downloaded by FSS 601 from a server computer in accordance with an embodiment of the present invention. In addition to a vendor downloadable software (VDS) 801, FSS 601 also downloads a configuration file 802, an installer 803, and a customization file 804.

In one embodiment, configuration file 802 is the first file downloaded by FSS 601. Configuration file 802 includes a list of files that would have to be downloaded from the server computer. In this embodiment, configuration file 802 includes the file name and location of VDS 801, installer 803, and customization file 804. Additional files may also be added to the list. As can be appreciated, configuration file 802 allows VDS 801, and its support files, to be updated without having to update FSS 601. This is a especially useful in situations where FSS 601 has been provided to a lot of vendors who have already bundled FSS 601 with their respective software.

Configuration file 802 further includes a bandwidth utilization value. In this embodiment, the bandwidth utilization value indicates the amount of bandwidth that download manager 603 should consume in downloading files. For example, if the desired bandwidth utilization is 15%, download manager 603 would adjust the size of the chunks and/or the amount of time used in downloading a series of chunks such that only approximately 15% of the available bandwidth on the network connection between the client computer and the server computer is utilized.

Referring again to FIG. 8, FSS 601 also downloads an installer 803 from the server computer. Installer 803 includes computer instructions for installing software downloaded to the client computer running FSS 601.

FSS 601 may also download a customization file 804 from the server computer. In this embodiment, customization file 804 contains dynamic link library (DLL) data for customizing a partner's user interface (e.g., user interface for installation of partner downloadable software). This allows each partner to have a unique look and feel for his software although all partners offer the same VDS 801 to their respective customers.

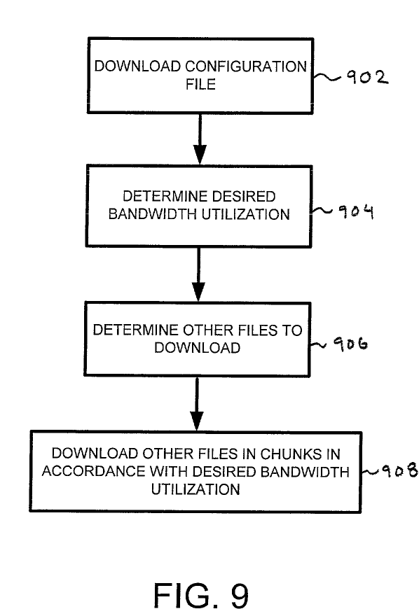

FIG. 9 shows a method for downloading files in accordance with an embodiment of the present invention. In action 902, download manager 603 downloads a configuration file 802. In action 904, download manager 603 determines the desired bandwidth utilization by reading a bandwidth utilization value indicated in the configuration file 802. In action 906, download manager 603 determines all the files needed to be downloaded from a list in the configuration file 802. In action 908, download manager 603 downloads all the files needed to be downloaded in chunks.

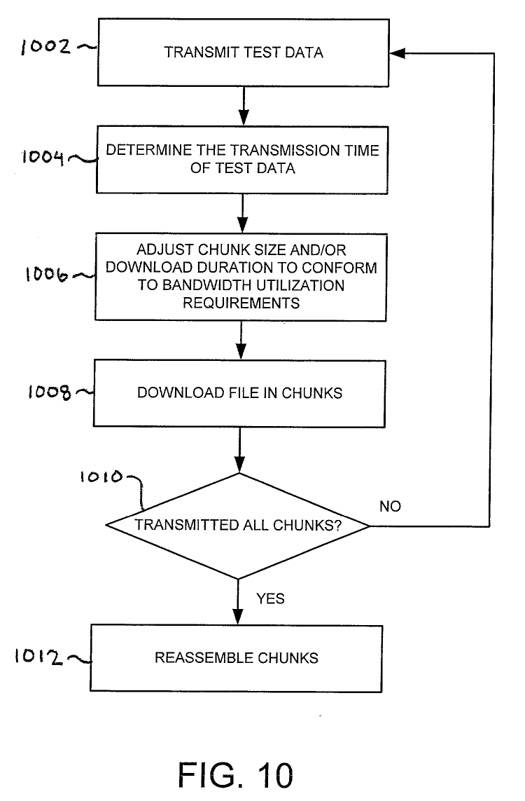

FIG. 10 shows a method for downloading a file in chunks in accordance with an embodiment of the present invention. In action 1002, download manager 603 transmits a test data to the server computer containing the file to be downloaded. In action 1004, download manager 603 determines the transmission time of the test data.

In action 1006, download manager 603 adjusts the size of each chunk of the file to be downloaded and/or the amount of time used in downloading a series of chunks (i.e., download duration) in order to conform to a desired bandwidth utilization. For example, if the desired bandwidth utilization is 25% of the available bandwidth of the network connection, transmitting a 64 kbyte chunk of data takes 700 mS to download with an inter-chunk sleep duration of 2100 mS (2.1 Seconds).

In action 1008, download manager 603 transmits an appropriately sized chunk or series of chunks for a certain period of time dictated by the desired bandwidth utilization. In action 1010, the aforementioned actions are repeated until all chunks of the file have been downloaded. In action 1012, the chunks are reassembled in the client computer after all the chunks have been downloaded.

An improved technique for downloading and distributing downloadable software over a network has been disclosed. While specific embodiments have been provided, it is to be understood that these embodiments are for illustration purposes and not limiting. Many additional embodiments will be apparent to persons of ordinary skill in the art reading this disclosure. Thus, the present invention is limited only by the following claims.

What is claimed is:

1. A method of receiving software over a network, the method comprising:
selecting an application software from a first web site coupled to a network;
downloading a packaging file on a client computer coupled to the network, the packaging file including the selected application software and a relatively small first stage software, the first stage software including instructions for downloading another application software from a second web site coupled to the network;
accepting the other application software for download from the second web site to the client computer;
running the first stage software; and
downloading the other application software onto the client computer.

2. The method of claim 1 wherein the other application software is divided into several chunks and each of the chunks is downloaded one after another onto the client computer.

3. The method of claim 1 wherein the first stage software has a size less than about 100 Kbytes when compressed.

4. The method of claim 1 wherein the network includes the Internet.

5. The method of claim 1 wherein the first stage software is included in the packaging file as part of an agreement between an operator of the first web site and another operator who wants to promote distribution of the other application software.

6. A method of obtaining software over a network, the method comprising:
selecting a first software from a first site;
downloading the first software on a client computer;
downloading a relatively small second software to the client computer in response to the selection of the first software, the second software including instructions for initiating a download of a third software from a site other than the first site; and
downloading the third software to the client computer as a series of individually downloadable portions.

7. The method of claim 6 wherein the third software is located on a second site that is linked to a third site, and the second software includes instructions identifying the third site as a source of the third software.

8. The method of claim 6 wherein the network includes the Internet.

9. The method of claim 6 wherein the third software includes an application software.

10. The method of claim 6 wherein the second software has a file size less than around 100 Kbytes when compressed.

11. A system for distributing software comprising:
a first server computer having a set of web pages and a first downloadable software;
a second server computer having another set of web pages, a second downloadable software, and a relatively small first stage software;
a client computer having a web browser, the client computer being configured to receive the first stage software by downloading the second downloadable software, the client computer being configured to receive the first downloadable software in chunks by following instructions included in the first stage software; and
a network coupling the first server computer, the second server computer, and the client computer.

12. The system of claim 11 wherein the network includes the Internet.

13. The system of claim 11 wherein the second downloadable software and the first stage software are bundled together in a single file.

14. The system of claim 11 wherein the second downloadable software and the first stage software are in separate files.

15. The system of claim 11 wherein the first stage software identifies a third server computer as a source of the first software, and the third server computer is linked to the first server computer.

16. A method of distributing software over a network, the method comprising:
bundling a first stage software with a first application software available for download from a first server computer;
storing a second application software on a second server computer, the second application software being offered to an end-user who wishes to download the first application software; and
downloading the second application software in chunks to an end-user who agrees to download the second application software, the second application software being downloaded in accordance with instructions included in the first stage software.

17. The method of claim 16 wherein the network includes the Internet.

18. The method of claim 16 further comprising:
checking if a new version of the first stage software exists prior to downloading the second application software.

19. The method of claim 16 further comprising:
offering a third application software to an end-user who wishes to download the first application software; and
downloading the third application software in chunks to an end-user who agrees to download the third application software.

20. The method of claim 16 wherein the first stage software is relatively small.

21. The method of claim 20 wherein the first stage software has a file size less than about 100 Kbytes when compressed.

22. A method of downloading a file from a server computer comprising:
downloading a configuration file, the configuration file identifying at least a first file to be downloaded; and
downloading the first file in chunks and in accordance with a desired bandwidth utilization.

23. The method of claim 22 wherein the desired bandwidth utilization is included in the configuration file.

24. The method of claim 22 further comprising:
keeping track of each chunk downloaded to a client computer designated to receive the first file; and
in the event of a download error, restarting the action of downloading the first file by downloading a next chunk following a chunk successfully downloaded to the client computer.

25. A method of downloading a file over a network comprising:
transmitting a test data;
determining the time it takes to transmit the test data to generate a bandwidth consumption figure; and
downloading a chunk of the file based on the bandwidth consumption figure and a desired bandwidth utilization.

26. The method of claim 25 further comprising:
keeping track of each chunk downloaded to a client computer designated to receive the file; and
in the event of a download error, restarting the downloading of the file by downloading a next chunk following a chunk successfully downloaded to the client computer.

27. The method of claim 25 wherein the action of downloading a chunk of the file based on the bandwidth consumption figure and a desired bandwidth utilization includes adjusting the size of the chunk.

28. The method of claim 25 wherein the action of downloading a chunk of the file based on the bandwidth consumption figure and a desired bandwidth utilization includes adjusting an amount of time allocated for transmitting the chunk.
